(19) United States
(12) Patent Application Publication
(10) Pub. No.: US 2004/0118621 A1
(43) Pub. Date: Jun. 24, 2004

(54) Live hydraulics for utility vehicles

(76) Inventor: Marc D. Curtis, Spencer, MA (US)

Correspondence Address: Kevin S. Lemack, Nields & Lemack, Suite 7, 176 E. Main Street, Westboro, MA, 01581, US

(21) Appl. No.: 10/698,268

(22) Filed: Oct. 31, 2003

Related U.S. Application Data
(60) Provisional application No. 60/434,555, filed on Dec. 18, 2002.

(51) Int. Cl. B60K 17/28

(52) U.S. Cl. 180/53.4

(57) ABSTRACT

A hydraulic system for an off-road vehicle such as a utility terrain vehicle. The hydraulic system of the present invention is coupled directly to the torque converter of the vehicle, and drives a hydraulic pump that provides both continuous hydraulic fluid as a power source (for working implements such as a jack hammer or hydraulic chain saw) and intermittent hydraulic fluid as a power source (to raise and lower a snow plow blade, for example). A clutch is used to engage or disengage the hydraulics when desired.

This application claims priority of Provisional Application Serial No. 60/434,555 filed on Dec. 18, 2002, the disclosure of which is hereby incorporated by reference.

### BACKGROUND OF THE INVENTION

Utility terrain vehicles or UTV's are versatile all-season three or four-wheeled motorized vehicles designed for off-road use. Typically ATV's are straddle-type vehicles, where the operator straddles the seat similar to a motorcycle or bicycle. They are generally designed to carry one or two passengers.

Various utilitarian accessories or implements, such as snowplow blades and dump bodies can be attached to the UTV and powered electrically by the UTV battery. However, the power capability of the UTV has limitations.

A typical transmission for small vehicles such as UTV's is an endless belt transmission or continuously variable transmission (“torque converter”), wherein both output torque and speed vary substantially continuously over the entire speed range of the engine. Such transmissions are well known in the art, and generally involve two pulleys, namely, a flyweight pulley driven by the vehicle engine and an output pulley used to power an output shaft which drives the wheels of the vehicle. An endless belt engages both pulleys. Effective pulley diameters are changed in order to change the torque available at the output shaft and the driven speed of the output shaft. For example, the pulley diameters are modified so that very high torque (at low rotational speed) is available as the vehicle moves from standstill while modest torque at high rotational speed is used for high-speed propulsion.

The present inventors have utilized this power system in order to provide an alternative power source for working implements.

It is therefore an object of the invention to provide an alternative power source for the UTV to power working implements.

It is a further object of the invention to provide hydraulic power generated from the UTV engine in order to power existing or add-on working implements for the UTV.

### SUMMARY OF THE INVENTION

The problems of the prior art have been overcome by the present invention, which provides a hydraulic system for an off-road vehicle such as a utility terrain vehicle. The hydraulic system of the present invention is coupled directly to the torque converter of the vehicle, and drives a hydraulic pump that provides both continuous hydraulic fluid as a power source (for working implements such as a jack hammer or hydraulic chain saw) and intermittent hydraulic fluid as a power source (to raise and lower a snow plow blade, for example). A clutch is used to engage or disengage the hydraulics when desired.

### BRIEF DESCRIPTION OF THE DRAWINGS

FIG. 1 is a perspective partial view of a utility terrain vehicle with the live hydraulics system in accordance with the present invention;

FIG. 2 is a perspective view of a torque converter and pulley system in accordance with the present invention;

FIG. 3 is a perspective view of a manifold having actuators in accordance with the present invention;

FIG. 4 is a perspective view of a the hydraulic fluid reservoir partially showing the dump body of the UTV in the upright position in accordance with the present invention;

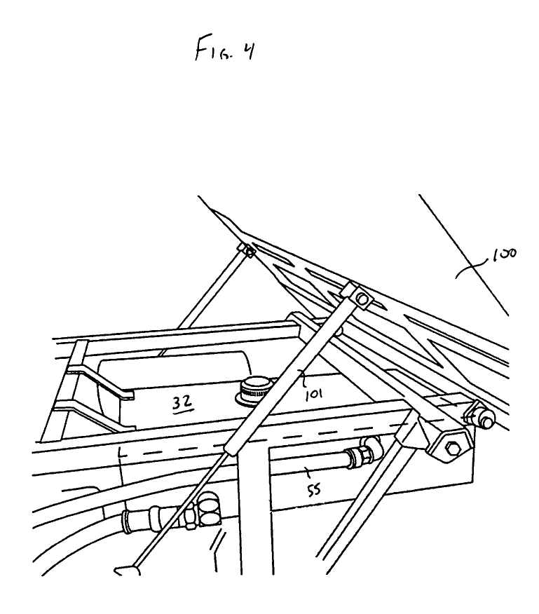

FIG. 5 is a perspective view of the manifold of FIG. 3 shown in fluid communication with the hydraulic pump in accordance with the present invention;

FIG. 6 is a perspective view of the hydraulic fluid reservoir showing the dump body of the UTV in the raised position in accordance with the present invention;

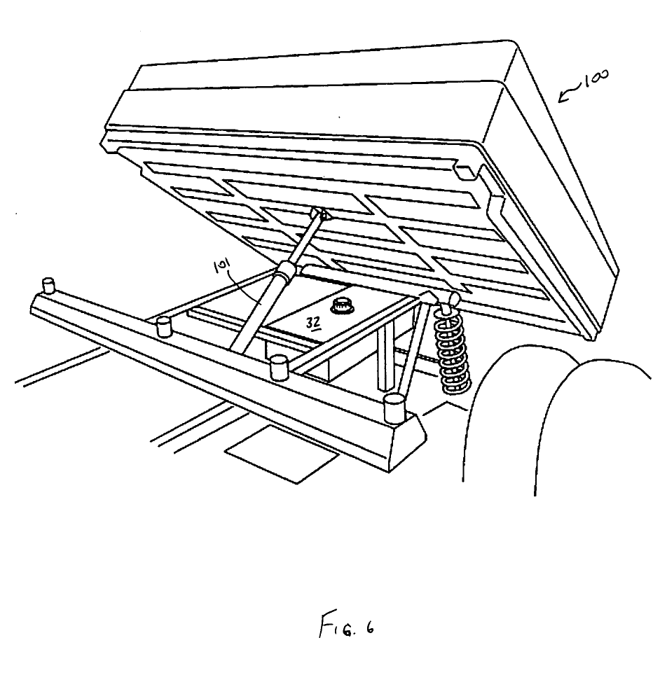

FIG. 7 is a perspective view of a clutch actuator in accordance with the present invention;

FIG. 8 is a perspective view of hydraulic quick disconnect ports in accordance with the present invention; and

FIG. 9 is a perspective view of hydraulic quick disconnect ports mounted to the vehicle front in accordance with the present invention.

### DETAILED DESCRIPTION OF THE INVENTION

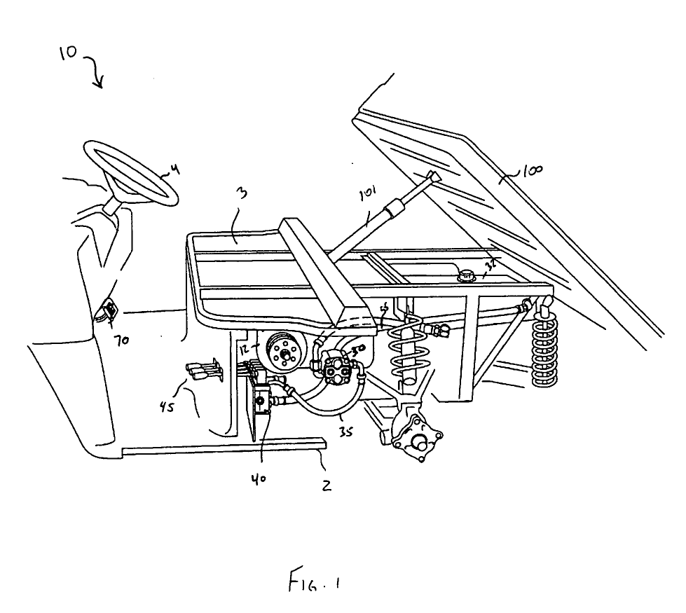

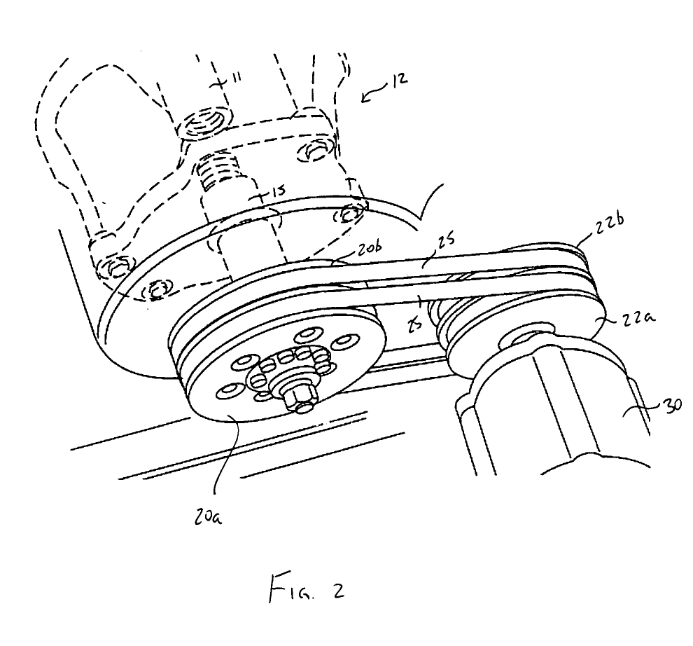

Turning first to FIG. 1, there is shown generally at 10 a UTV suitable for mounting of the hydraulic system in accordance with the present invention. The UTV shown has a seat 3 mounted on chassis 2, the seat being generally suitable for a driver and a passenger, a steering wheel 4, four wheels (not shown), and a dump body 100. UTV's typically have engines capable of less than about 40 horsepower, more typically less than about 35 horsepower, and especially 32 horsepower or lower. The engine includes a conventional torque converter 12 including a variable ratio drive pulley (not shown) well known to those skilled in the art. Conveniently, the drive pulley shaft 11 (FIG. 2), that is typically coupled to the engine crank shaft (not shown), includes a female thread for attachment of a male threaded tool to disassemble and assemble the converter.

In accordance with a preferred embodiment of the present invention, a shaft extension 15 with male threads is threadingly coupled to the drive pulley shaft 11 or crank shaft. Those skilled in the art will appreciate that other means for coupling the shaft extension 15 to the drive pulley shaft 11 or crank shaft can be used particularly where the drive pulley shaft or crank shaft is not internally threaded.

The shaft extension 15 supports at least one drive pulley, preferably two drive pulleys 20a, 20b in view of the relatively high torque involved (two pulleys are preferred in order to minimize or eliminate belt slippage). The drive pulleys 20a, 20b drive respective driven pulleys 22a, 22b (a single driven pulley can be used in the case where a single drive pulley is used) via belts or chains 25. At least one of either the drive pulley(s) or driven pulley(s) preferably is axially adjustable to assist in aligning the belt(s). The driven pulleys 22a, 22b drive hydraulic fluid pump 30, which is in fluid communication with hydraulic fluid contained in a reservoir 32 via hose 55. The hydraulic pump 30 supplies pressurized hydraulic fluid to power one or more working implements.

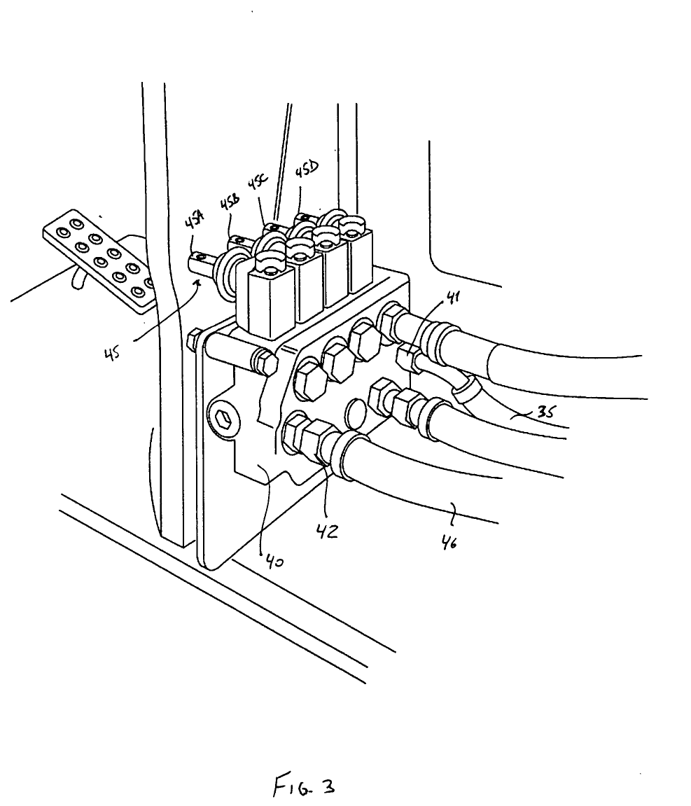

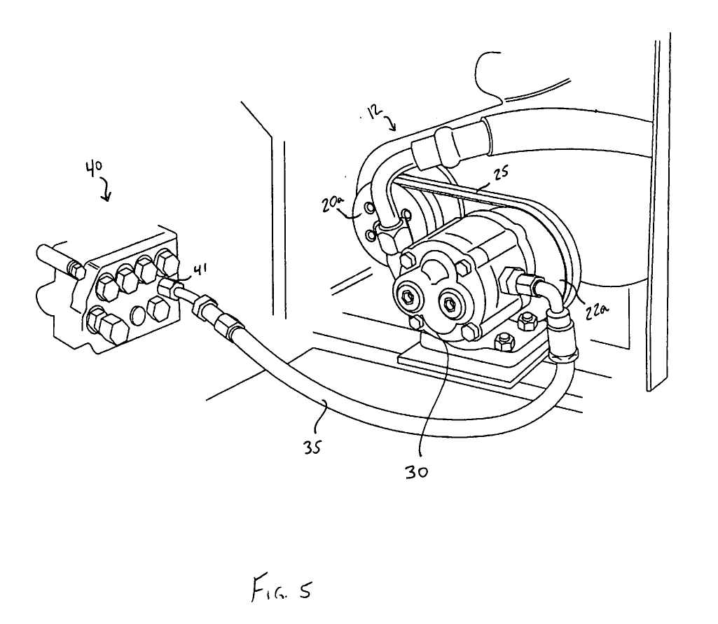

Manifold 40 (best seen in FIGS. 3 and 5) includes an input 41 for receiving pump pressure via hose 35. Output 42 returns fluid back to the reservoir via hose 46. The manifold 40 also includes a plurality of actuators 45 for working one or more working implements. For example, actuator 45A can raise or lower a snowplow blade. Actuator 45B can angle a snowplow blade. Actuator 45C can actuate the hydraulic cylinder 101 that raises and lowers the dump body 100. Actuator 45D can engage a working implement not attached to the vehicle, such as a jackhammer or chain saw.

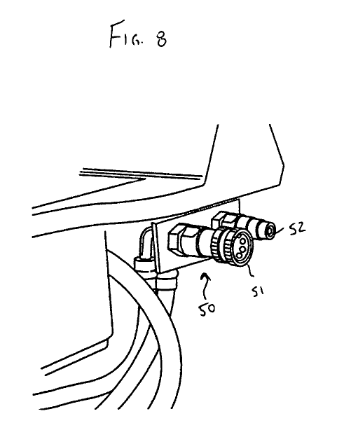

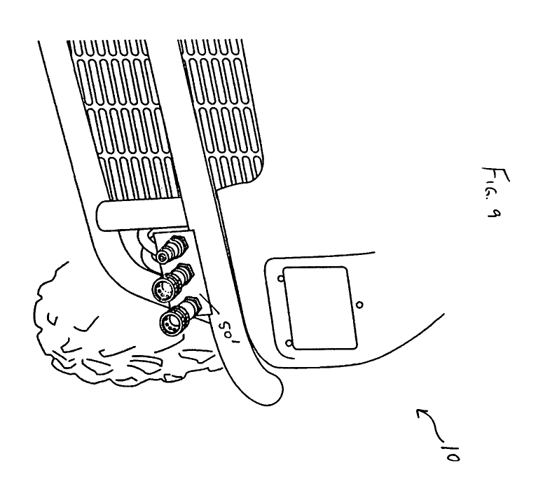

Turning now to FIG. 8, bulkhead 50 includes a female quick-disconnect coupling 51 and a male quick-disconnect coupling 52 to provide fluid power to a working implement that utilizes continuous hydraulics. One of the couplings is in fluid communication with the hydraulic pump via suitable hosing for supplying power to the implement. The other is in fluid communication with the hydraulic fluid reservoir via suitable hosing for returning hydraulic fluid to the reservoir after passing through the working implement. The location of the bulkhead 50 (and of the couplings) is not particular limited; it is preferably placed in a convenient location for easy operator access. For example, suitable couplings can be mounted at the front of the vehicle on bulkhead 50′ as shown in FIG. 9 for driving working implements that are mounted at or near the vehicle front, such as plows, blowers and sweepers.

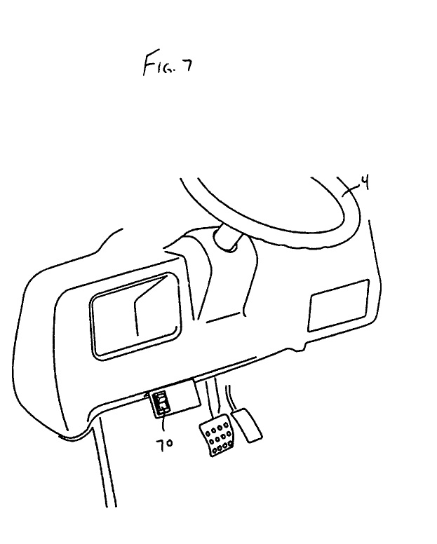

FIG. 7 illustrates a switch or actuator 70 in electrical communication with a clutch (not shown). Upon actuation of the switch 70, the clutch engages the pulley system of the present invention, resulting in the flow of hydraulic fluid. Conventional clutch designs well known to those skilled in the art are suitable.

What is claimed is:

1. A hydraulic system for operating a working implement with an off-road vehicle, said vehicle having a torque converter including a shaft and a drive system comprising a pulley driven by said shaft, and an output pulley driven by said pulley via a continuous belt, said hydraulic system comprising:
a shaft extension coupled to said shaft and supporting at least one drive pulley;
at least one driven pulley coupled to said at least drive pulley via an endless belt; and
a hydraulic pump driven by said driven pulley, said hydraulic pump adapted to be in fluid communication with hydraulic fluid.

2. The hydraulic system of claim 1, further comprising a clutch for engaging said hydraulic system.

3. The hydraulic system of claim 1, further comprising a second drive pulley and a second driven pulley coupled to said second drive pulley via a second endless belt.

4. The hydraulic system of claim 1, further comprising one or more actuators for diverting hydraulic fluid from said pump to a working implement.

5. The hydraulic system of claim 1, wherein said working implement is a snow plow blade.

6. The hydraulic system of claim 1, wherein said working implement is a dump body.

7. The hydraulic system of claim 1, wherein said working implement is a chain saw.

8. The hydraulic system of claim 1, wherein said working implement is a jack hammer.
